(19) United States
(12) Patent Application Publication
(10) Pub. No.: US 2007/0262178 A1
(43) Pub. Date: Nov. 15, 2007

(54) Syringe delivery tip including an enlarged flocked wing element adjacent a distal delivery end

(75) Inventors: Dan E. Fischer, Sandy, UT (US); Bruce S. McLean, Sandy, UT (US)

Correspondence Address: WORKMAN NYDEGGER, 60 EAST SOUTH TEMPLE, 1000 EAGLE GATE TOWER, SALT LAKE CITY, UT, 84111, US

(73) Assignee: Ultradent Products, Inc., South Jordan, UT (US)

(21) Appl. No.: 11/433,289

(22) Filed: May 12, 2006

(51) Int. Cl. B05B 15/08; A62C 31/02; B05B 1/00

(52) U.S. Cl. 239/602; 239/589; 239/588

(57) ABSTRACT

A delivery tip for dispensing a high viscosity composition (e.g., a fluoride varnish composition) includes a tip body and a fiber flocked enlarged wing element disposed near a distal delivery end of the tip body. The tip body includes a passageway extending between an inlet orifice at a proximal end and a delivery orifice at the distal delivery end. A ratio of the width of the enlarged wing element to an inside diameter of the delivery orifice is at least about 5:1, which controls flow of the fluoride varnish composition through the delivery orifice while also providing for a wide application width for easily brushing the composition onto a patient's tooth.

### BACKGROUND OF THE INVENTION

1. The Field of the Invention

The present invention relates to dental delivery tools and components thereof for use in dentistry and medicine and other fields. More particularly, the present invention is directed to dental delivery tips and systems configured for insertion into the mouth of a patient and having a plurality of fibers disposed along a desired length of the distal delivery end portion of the delivery tip.

2. The Relevant Technology

In the field of dentistry, a fluoride composition is often applied to a patient's teeth as part of a routine dental cleaning. Fluoride compositions are often applied to children's teeth to prevent tooth decay, although they are sometimes applied to adult teeth as well. Application of fluoride has been widely recognized as a method of preventing tooth decay as it hardens the surface of enamel by forming calcium fluoride.

According to one method, a fluoride gel composition is dispensed within a dental tray, after which the tray is placed over the patient's teeth. The tray holds the fluoride gel composition adjacent to the patient's teeth. After a desired amount of time (e.g., a few minutes or less), the tray is removed, and the remaining gel composition is rinsed off the patient's teeth. Because short exposure times of the patient's teeth to the fluoride gel composition may be inadequate to delivery sufficient fluoride to have a desired effect, alternative methods that allow increased exposure time (and thus more effective tooth decay prevention) to the fluoride have been developed.

One such method involves application of a fluoride varnish composition to a patient's teeth. A typical fluoride varnish composition includes a fluoride salt dispersed within a sticky, adhesive hydrophobic varnish material. The fluoride varnish composition is typically stored within a foil covered tray, allowing the dental practitioner to peel away the cover, dip a brush into the tray, and brush the mixture onto the patient's teeth. Once applied, the varnish composition adheres to the teeth, allowing a longer exposure time (e.g., as long as, or greater than 2 hours) before the varnish composition is eroded away by the action of saliva and/or the patient's tongue.

Although such fluoride varnish compositions allow for longer exposure times, existing methods of fluoride varnish application have disadvantages. First, varnish components are typically multi-phase such that the fluoride salt is insoluble, causing the solid fluoride salt phase to settle out of the mixture during storage. Because of this, the dental practitioner is required to stir the mixture (e.g., with a stirring stick) prior to application. This mixing process requires use of an extra tool (i.e., a stirring stick), is inefficient and wasteful (i.e., the varnish adhering to the stick is unavailable for placement onto a person's teeth), and fails to ensure complete mixing.

In order to address this difficulty, an alternative method has been recently developed which preferably involves mixing the fluoride varnish composition within a two-part closed vessel (e.g., a syringe-to-syringe mixing apparatus). Once mixed, the syringes or other closed vessels can be decoupled, and the composition can be dispensed from one of the syringes. Although the composition can be dispensed through a syringe tip in this way, or through one of a variety of existing delivery tips coupled to the syringe, it would be an advantage to provide a delivery tip that could provide improved flow control of the high viscosity fluid, while also providing a wide application width for brushing the viscous composition onto the teeth.

### BRIEF SUMMARY OF THE INVENTION

The present invention is directed to a delivery tip and a related delivery system including the delivery tip and a container (e.g., a syringe) for use in dispensing, applying, and brushing a fluoride varnish composition or other high viscosity dental composition onto a desired surface (e.g., the exterior surface of a tooth). The inventive delivery tip includes a tip body including a passageway through which a dental composition may pass. The passageway extends from an inlet orifice at a proximal end of the tip body to a delivery orifice at a distal delivery end of the tip body. The delivery tip advantageously further includes an enlarged wing element adjacent the distal delivery end. The wing element extends substantially laterally outwardly from the distal delivery end, and is preferably planar in profile. A plurality of fibers (e.g., flocked fibers or other fibrous material) are disposed on at least a portion of the wing element. Advantageously, the ratio of the width of the enlarged wing element relative to the inside diameter of the delivery orifice is at least about 5:1.

Forming the device to include both an enlarged wing element and a relatively small delivery orifice (i.e., so that the ratio of the width of the enlarged wing element relative to the inside diameter of the delivery orifice is at least about 5:1) advantageously provides control over the flow of high viscosity composition out of the delivery orifice, while also providing for a relatively wide application width because of the enlarged wing element disposed near the relatively small delivery orifice. The small inside diameter of the delivery orifice provides control over flow of the high viscosity composition as it eliminates or reduces the tendency of a high viscosity liquid composition (e.g., a composition having a viscosity of at least about 1000 centipoise) to otherwise run or drip out the orifice absent an active driving force. In other words, the small orifice presents an environment where the liquid will not flow except when a force is applied by the practitioner. The relatively large application brushing width provided by the wing element width (e.g., about 3.5-6 mm) is particularly beneficial as this width (augmented by the length of the fibers attached to the wing element) provides an application width that closely matches the height of a typical child's molar to which the composition may be being applied.

Because the delivery tip includes a delivery orifice having a relatively small inside diameter, the delivery tip is able to control flow of a high viscosity composition as it is delivered for application. Because the delivery tip also includes a wing element extending laterally outwardly from the distal delivery end (i.e., near the delivery orifice) that is at least about 5 times wider than the inside diameter of the delivery orifice, the delivery tip is also well adapted for brushing or otherwise applying the composition in a wide application width as it exits the delivery orifice. The inventive tip advantageously is configured to apply a composition in a much wider width than a flocked applicator tip of small delivery orifice diameter that includes no wing element extending laterally outwardly adjacent the delivery orifice. Likewise, the inventive delivery tip is configured to better control the flow (i.e., by requiring an active driving force applied by the user in order to cause the composition to flow) of a high viscosity composition compared to a wider tip having a relatively large inside diameter delivery orifice.

In one example, the width of the enlarged wing element is between about 2.5 and about 12 mm, preferably between about 3 and about 9 mm, and most preferably between about 3.5 and about 6 mm. The inside diameter of the delivery orifice is relatively small compared to the width of the wing element. In one example, the delivery orifice is characterized by an inside diameter between about 0.003 and about 0.04 inch (about 0.075 mm to about 1 mm), preferably between about 0.005 and about 0.03 inch (about 0.125 mm to about 0.75 mm), and most preferably between about 0.01 inch and about 0.025 inch (about 0.25 mm to about 0.65 mm). Providing a ratio of the wing element width to delivery orifice inside diameter of at least about 5:1 provides good flow control through the orifice while simultaneously providing an application width that is substantially wider than the delivery orifice. Providing even greater ratios of wing element width to delivery orifice inside diameter (e.g., at least about 9:1, at least about 15:1, or at least about 20:1) has been found to provide for an even better combination of flow control properties and enlarged application surface width.

By way of more specific example, the most preferred range of delivery orifice inside diameter between about 0.01 inch and about 0.025 inch provides for excellent flow control properties as it requires application of a force by the practitioner to cause the composition to flow, which reduces or prevents unintentional running or dripping of the composition out of the delivery orifice, which is messy and wasteful. The most preferred range of wing element width between about 3.5 and about 6 mm is particularly advantageous as it results in an application width (wing element width plus fiber length) that closely matches the width of a child's molar, and is therefore very useful and efficient when applying the composition to a child's molars. The above ranges for delivery orifice inside diameter and wing element width correlate to a ratio of wing element width to delivery orifice inside diameter between about 6:1 and about 24:1.

Although described in the context of delivering and applying a viscous fluoride varnish composition, those skilled in the art will appreciate that the inventive delivery tips may be useful in delivering other viscous compositions (whether dental, medical, or in other fields) where control over fluid flow and a wide application width would be desirable.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view of an exemplary embodiment of a fiber flocked delivery tip including an enlarged wing element;

FIG. 1B is a cross-sectional view of the delivery tip of FIG. 1A;

FIG. 1C is an end perspective view of the delivery tip of FIG. 1A;

FIG. 1D is an end perspective view of an alternative delivery tip including a wing element having a width at least about 9 times greater than the inside diameter of the delivery orifice;

FIG. 1E is an end perspective view of an alternative delivery tip including a wing element having a width at least about 15 times greater than the inside diameter of the delivery orifice;

FIG. 1F is a cross sectional view of the delivery tip of FIG. 1A, the cross-section being taken along a plane transverse to that of FIG. 1B illustrating the flexible nature of a tip according to the invention;

FIG. 1G is a side view of the delivery tip of FIG. 1A;

FIG. 2A is a perspective view of an alternative delivery tip including an enlarged wing element illustrating the flexible nature of a tip according to the invention;

FIG. 2B is a perspective view of the delivery tip of FIG. 2A and a syringe to which the delivery tip is coupleable; and

FIGS. 3A and 3B illustrate the delivery system of FIG. 2B being used to apply a fluoride varnish composition to the molars of a child patient.

### DETAILED DESCRIPTION OF THE PREFERRED EMBODIMENTS

I. Introduction

The invention is directed to a delivery tip and a related delivery system including the delivery tip and a container (e.g., a syringe) that is particularly well suited for use in dispensing and brushing or otherwise applying a highly viscous dental composition. The inventive delivery tip comprises a tip body, including a passageway through which a high viscosity dental composition (e.g., a fluoride varnish composition having a viscosity of at least about 1000 centipoise) may be delivered. The passageway extends from an inlet orifice adjacent a proximal end of the tip body to a delivery orifice adjacent a distal delivery end of the tip body. The proximal end of the tip body is coupleable to a syringe or other container for holding and supplying a high viscosity dental composition to be dispensed through the tip. The delivery tip advantageously includes a plurality of fibers (e.g., electrostatically applied fiber flocking) attached to an enlarged wing element disposed adjacent to the distal delivery end of the tip. The wing element is relatively thin and planar and extends substantially laterally outwardly from the distal, delivery end. Advantageously, the width of the enlarged wing element is at least about 5 times wider than the inside diameter of the delivery orifice. Such a configuration provides a particularly advantageous oz combination of control over the flow of composition through the delivery orifice (i.e., because of the small inside diameter of the orifice) while also providing a relatively wide application width (i.e., because of the enlarged wing element and the plurality of fibers attached thereto) adjacent the delivery orifice.

II. Exemplary Delivery Tips and Systems

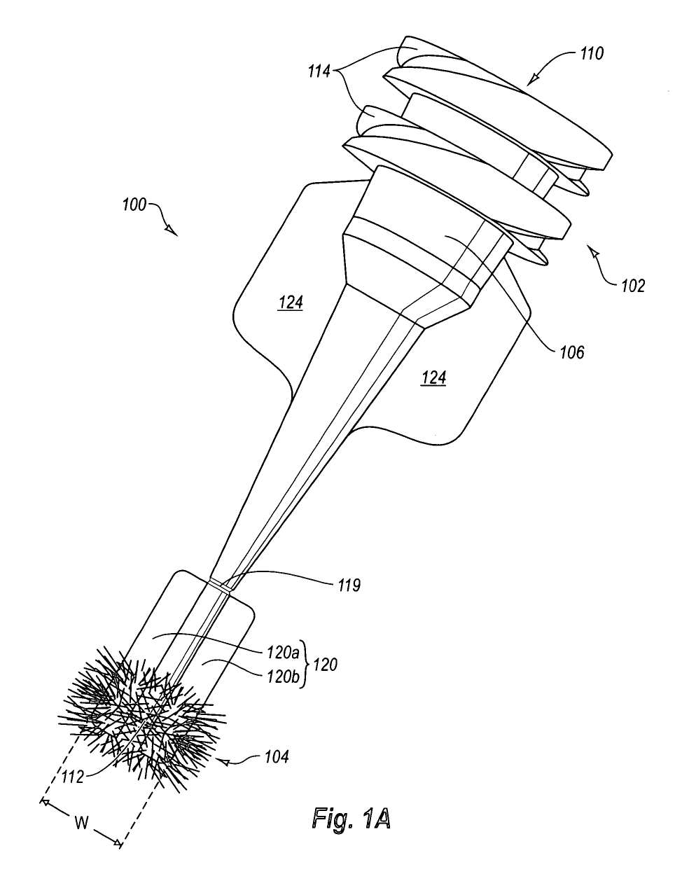

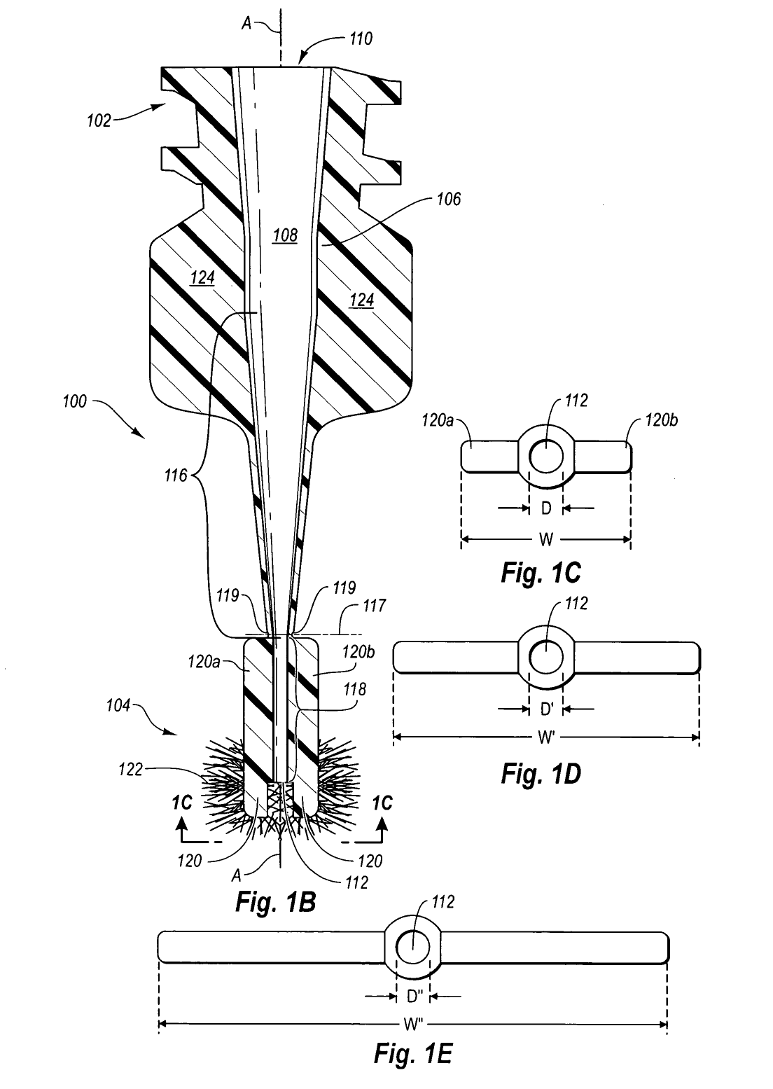

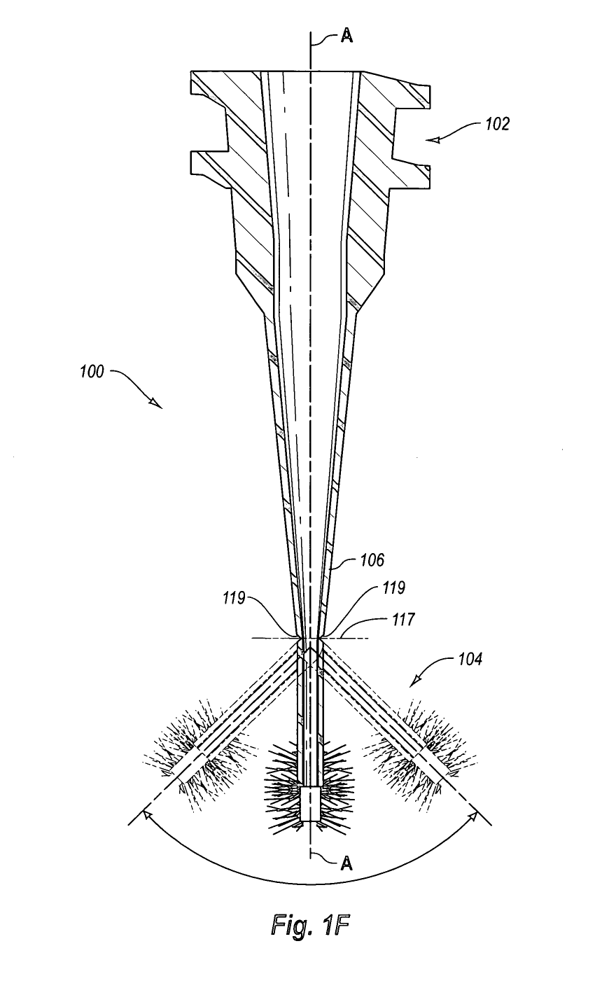

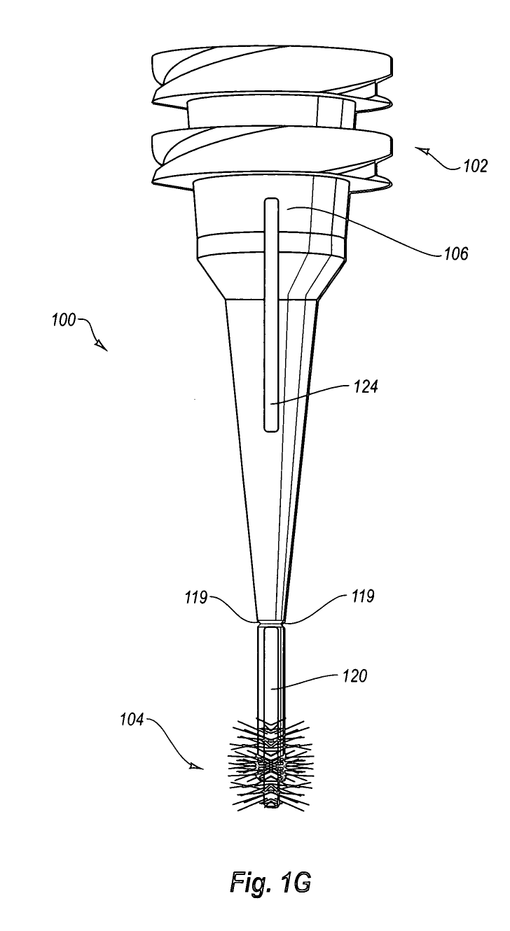

FIGS. 1A-1C illustrate an exemplary delivery tip 100. Delivery tip 100 includes a proximal end 102 and a distal delivery end 104. Delivery tip 100 includes a tip body 106, having a passageway 108 through which a high viscosity dental composition may be forced for delivery. As perhaps best seen in FIG. 1B, passageway 108 extends between an inlet orifice 110 adjacent proximal end 102 and a delivery orifice 112 adjacent distal delivery end 104. As illustrated in FIG. 1A, proximal end 102 includes coupling means for coupling delivery tip 100 to a syringe or other container from which the composition is to be dispensed. Illustrated proximal end 102 includes a pair of spaced apart threads 114 for coupling to a syringe or other container. Additional details of such a coupling configuration and additional coupling means are disclosed in U.S. patent application Ser. No. 11/235,461 titled SYRINGE LOCKING STRUCTURES and filed Sep. 26, 2005, and U.S. Pat. No. 6,610,034, both of which are incorporated by reference with respect to their disclosure of coupling configurations. Single threads well known in the art can also be used. Torque flanges 124 may also be included near coupling threads 114. Torque flanges 124 are helpful in applying torque to the delivery tip 100 in order to more easily couple it to another device (e.g., a syringe).

Passageway 108 (FIG. 1B) advantageously is of a relatively wide diameter at the inlet orifice 110, and narrows so as to be of a smaller diameter at delivery orifice 112. Providing a wide diameter entrance at inlet 110 allows the composition to easily enter passageway 108 from a syringe or other container. Small diameter outlet 112 advantageously provides better flow control for the viscous dental composition to be delivered. In the illustrated embodiment, passageway 108 may advantageously be formed such that the defined hollow passageway 108 includes a gradually tapered portion 116, which advantageously narrows passageway 108 towards delivery orifice 112. Beyond tapered portion 116 near distal end 104, passageway 108 may include an untapered portion 118 of uniform cross sectional diameter along the remaining length (e.g., between about 3 and about 15 mm) of passageway 108. The inside diameter of portion 118 is advantageously relatively small so as to provide control over fluid flow through passageway 108 by requiring an actively applied force to cause fluid to flow out of delivery orifice 112. This configuration prevents a high viscosity fluid (e.g., a composition having a viscosity of at least about 1000 centipoise) from flowing simply under the influence of gravity, which would otherwise prevent the user from having complete control over fluid flow and delivery, resulting in waste, mess, and increased frustration for both the dental practitioner and the patient. For example, a composition having an unpleasant taste might drip from delivery orifice 112 while the delivery tip is in the patient's mouth, coming into contact with the patient's tongue.

The delivery orifice 112 is advantageously of an internal diameter sufficiently small to result in a total pressure drop along the length of passageway 108 so as to minimize or eliminate any tendency of a viscous liquid to run or drip out of delivery orifice 112 under ambient conditions absent a force intentionally applied by the user. The inventors have found that an inside diameter between about 0.003 and about 0.04 inch (about 0.075 mm to about 1 mm), preferably between about 0.005 and about 0.03 inch (about 0.125 mm to about 0.75 mm), and more preferably between about 0.01 and about 0.025 inch (about 0.25 mm to about 0.65 mm) is particularly suited for this purpose when used to dispense a fluoride varnish composition having a viscosity between about 1000 centipoise and about 3500 centipoise, more particularly between about 1700 and about 2800 centipoise.

Adjacent to distal end 104 is disposed a relatively thin, substantially planar enlarged wing element 120 that extends substantially laterally outwardly relative to longitudinal axis A. Wing element 120 includes two sub-portions 120a and 120b, each sub-portion extending laterally outwardly from opposite sides of tip body 106 such that the two sub-portions 120a and 120b are in substantially the same plane. In other words, wing element 120 advantageously extends outwardly in a substantially perpendicular direction relative to longitudinal axis A, and sub-portions 120a and 120b are substantially 180° apart (i.e., extend in essentially opposite directions). Wing element 120 is advantageously thin (e.g., between about 0.2 mm and about 1 mm), which increases bendability and flexibility of wing element 120. Wing element 120 may extend proximally any desired length. Advantageously, wing element 120 is formed so as to have a total width that is at least about 5 times greater than the inside diameter of delivery orifice 112.

The ratio of the wing element width (see FIG. 1C) to the delivery orifice 112 inside diameter is advantageously at least about 5:1, although the ratio may be even greater. For example, FIG. 1D illustrates an embodiment having a ratio of wing element width W′ to delivery orifice inside diameter D′ of about 9:1, and FIG. 1E illustrates an embodiment having a ratio of wing element width W″ to delivery orifice inside diameter D″ of about 15:1. Table 1 below gives several examples of wing element total width, delivery orifice inside diameter, and resulting ratios according to the present invention.

TABLE 1

| | | |
|---|---|---|
| Wing Element Total Width | Inside Diameter | Ratio W/D |

| | | | |
|---|---|---|---|
| 2.5 mm (0.10 in) | 0.02 | in | 4.9 |
| 3.0 mm (0.12 in) | 0.015 | in | 7.9 |
| 3.5 mm (0.14 in) | 0.003 | in | 45.9 |
| 3.5 mm (0.14 in) | 0.01 | in | 13.8 |
| 3.5 mm (0.14 in) | 0.025 | in | 5.5 |
| 6.0 mm (0.24 in) | 0.01 | in | 23.6 |
| 6.0 mm (0.24 in) | 0.025 | in | 9.4 |
| 6.0 mm (0.24 in) | 0.04 | in | 5.9 |
| 8.0 mm (0.31 in) | 0.015 | in | 21.0 |
| 10.0 mm (0.39 in) | 0.03 | in | 13.1 |
| 12.0 mm (0.47 in) | 0.04 | in | 11.8 |

Although each embodiment illustrates delivery orifice 112 as being centrally located through the midpoint of the wing element 120, it is within the scope of the invention to shift delivery orifice 112 toward one side or the other of the wing element 120. Centrally locating delivery orifice 112 relative to wing element 120 is generally most advantageous as it provides for the best distribution of the composition as it exits orifice 112 and is caught by fibers attached to the wing element 120. In effect, such a configuration minimizes the distance the composition must travel to reach each end of the wing element 120, which facilitates good distribution of the composition throughout the plurality of fibers along the full length of the wing element 120.

In one embodiment, it may be particularly advantageous for the wing element width to provide an application width (i.e., approximately the wing element width plus twice the average fiber length) that is approximately equal the height of a person's molar to which a fluoride varnish composition is to be applied. In one such example, the wing element width is between about 2.5-12 mm, more preferably between about 3-9 mm, and most preferably between about 3.5-6 mm. The larger widths within these ranges (e.g., about 8-12 mm) may be particularly useful for applying a fluoride varnish composition to an adult's molars. The shorter widths, particularly those of about 3.5-6 mm, are particularly useful for applying a fluoride varnish composition to a child's molars.

A plurality of fibers 122 are advantageously attached to at least the distal portion of wing element 120. Fibers 122 preferably have a fiber length between about 0.3 mm and about 3 mm, more preferably between about 0.5 mm and about 2 mm. Fibers 122 may have a diameter between about 1 Denier and about 100 Denier, more preferably between about 1.5 Denier and about 10 Denier. Actual selected fiber length and diameter may depend on the viscosity, surface tension, cohesiveness, and other physical properties of the composition to be delivered through the delivery tip 100. The fibers 122 together with wing element 120 provide an application width that is approximately equal to the wing element width plus twice the average fiber length. For example, when applying a fluoride varnish composition to a child's molars, it is particularly helpful for the total application width to be between about 6-8 mm, as this is the approximate height of a typical child's molars. For an adult, the total application width is advantageously about 10-14 mm.

Fibers 122 can include short and long fibers such that longer fibers are supported by shorter fibers. The fibers may be attached to the wing element in a variety of different manners, such as through flocking, e.g., electrostatic flocking, gravity flocking, and a variety of other flocking methods. Such flocking may occur through a variety of different procedures, such as disclosed in U.S. Pat. No. 6,286,246 entitled “Electrostatically Flocked Fishing Lures and Related Systems and Methods,” which is incorporated herein by reference.

According to one flocking method, an adhesive material is applied to at least a portion of wing element 120 where fiber attachment is desired. An appropriate quantity of fibers is then contacted with the adhesive material. The adhesive is allowed to harden or cure, thereby securing the fibers to the desired portion of wing element 120. Both natural and synthetic fibers may be used. Suitable natural fibers include cotton fibers, while suitable synthetic fibers include nylon and polyester fibers. In addition, various injection moldable plastics can be employed to form the fibers of the present invention using standard injection molding techniques.

In the illustrated embodiment, the distal end of wing element 120 extends distally beyond delivery orifice 112. This configuration more easily allows a high viscosity composition exiting through orifice 112 to be caught by fibers 122, where it can subsequently be effectively applied to a selected surface (e.g., a person's molars and/or other teeth).

It will also be noticed that the delivery orifice 112 is not substantially obstructed by fibers 122 or other structure, which might otherwise impede or completely prevent the flow of a high viscosity composition through orifice 112. In other words, fibers 122 advantageously do not significantly add to the total pressure drop as fluid passes through passageway 108 and out orifice 112 as might otherwise occur if a foam or other porous plug were fitted over delivery orifice 112.

The relatively small internal diameter of delivery orifice 112 restricts, but does not completely preclude, flow through the orifice 112. For example, a typical fluoride varnish composition having a viscosity of at least about 1000 centipoise will not readily flow through delivery orifice 112 absent an expulsion pressure (e.g., applied by the dental practitioner). Advantageously, this prevents the varnish composition from running or dripping out of the delivery tip, resulting in a mess or dripping into the mouth of the patient, which could be particularly undesirable if the composition has an undesirable taste. Forming the distal portion 118 of passageway 108 so as to be of approximately the same relatively small inside diameter as delivery orifice 112 advantageously provides further control over the flow of material through orifice 112, as the small internal diameter over the length of portion 118 results in increased total pressure drop relative to what the total pressure drop would be if portion 118 of passageway 108 were of a significantly larger internal diameter, and only delivery orifice 112 were of a relatively small diameter.

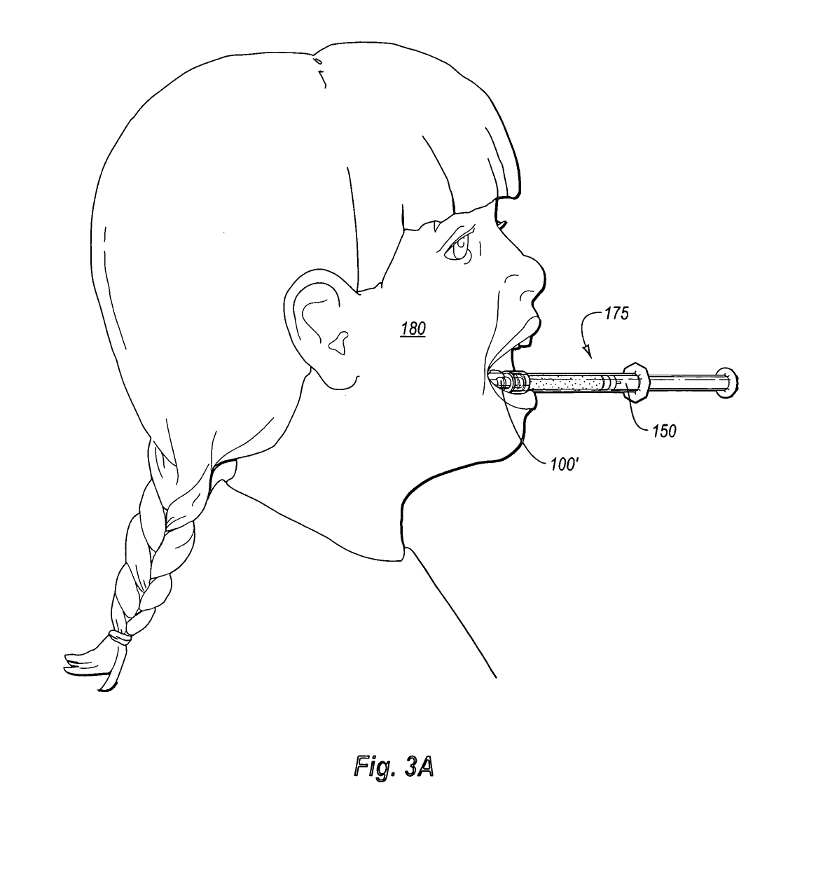

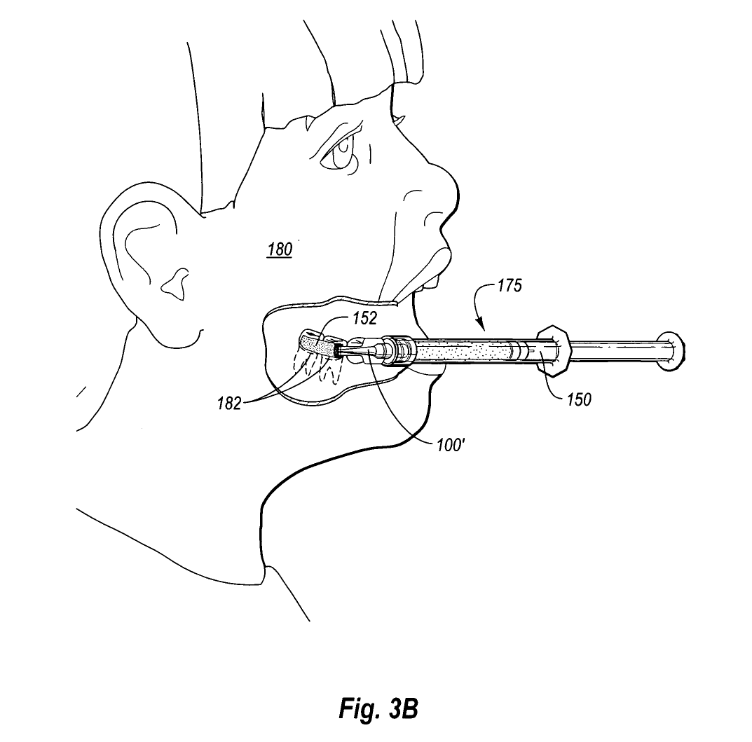

FIG. 1F is an alternative cross sectional view through delivery tip 100, showing a cross section that is transverse to that illustrated in FIG. 1B. FIG. 1G illustrates a side perspective view of delivery tip 100. FIG. 1F illustrates the bendability of the distal portion of tip 100. Forming a distal portion of tip 100 so as to be bendable advantageously allows the tip to be bent (e.g., either during manufacture or by the end user) to an angle beneficial for applying the dental composition. The ability to bend the distal portion to even a shallow angle (e.g., about 15°) relative to the central and/or proximal portion of the delivery tip 100 aids the practitioner in retaining composition on the fibers (particularly the fiber surface opposite the inside of the patient's cheeks) while reaching back to the labial surface of a patient's molars for application of the composition (see FIGS. 3A-3B). In addition, the bendable angled configuration aids in assuring that the highly viscous composition is applied into the interproximal spaces between the teeth as the enlarged wing element 120 of delivery tip 100 is pulled across the labial tooth surfaces, beginning with the rearmost molar.

Furthermore, providing a flexible, bendable distal portion within delivery tip 100 may be advantageous over a rigid and angled configuration as it allows the distal tip portion to “bounce” along the tooth surface during use. The bendability of the tip results in a certain amount of “give” or “bounce” which can provide an increased degree of comfort to the patient as compared to a rigid distal portion. This bounce characteristic also aids in reaching the interproximal spaces between the teeth because the force applied against the teeth causes the tip to bend to a decreased angle, and as the tip is pulled toward the front of the mouth the tip will bounce back from the decreased angle as the interproximal space between teeth is reached, helping the tip to press more firmly into the interproximal space so as to result in composition being deposited there.

In the illustrated embodiment of FIG. 1B, proceeding distally from proximal end 102, the passageway 108 reaches its smallest inside and outside diameter at plane 117, about which the distal portion of delivery tip 100 will bend if a bending force is applied at one end relative to the other. For example, if the proximal end 102 is held stationary while pushing on one side of distal end 104, the portion of delivery tip 100 distal to plane 117 will bend relative to that portion of tip 100 that is proximal to plane 117. In other words, plane 117 comprises a plane of bendability about which the distal portion of tip 100 is bendable. This is perhaps best seen in FIG. 1F, which shows the distal portion of tip 100 being bendable in either direction to about 45° relative to axis A. It may be beneficial to form one or more notches 119 into body 106 at plane 117, so as to further define the plane about which distal end 104 bends. Notches 119 further direct any applied bending force so as to cause delivery tip 100 to bend at plane 117 when such a force is applied.

Preferably, the distal portion of the tip is sufficiently flexible or bendable so that it can be bent to an angle between about 20° and about 70° relative to the proximal tip portion, more preferably between about 30° and about 60°, and most preferably between about 40° and about 50°. In some embodiments it may be necessary to bend the tip beyond the desired angle such that when the bending force is released, the distal portion of the tip will rebound back part way. For example, initially bending the distal tip to about 90° may result in an angle of about 45° after the bending force is released and the tip allowed to partially rebound. In other words, the bendable region may not be completely resilient which would otherwise cause the tip to return to a straight pre-bent configuration once the deforming force is released. The material and thickness of at least the flexible and/or bendable portion surrounding plane 117 is preferably durable so as to allow bending of the distal portion multiple times without cracking, splitting, or significant crazing, which may otherwise lead to premature failure of delivery tip 100. Notches 119 may be helpful in reducing any tendency to crack, craze, or split.

In the example illustrated in FIGS. 1A-1B and 1F, the entire delivery tip may be injection molded from a plastic material. Suitable injection molding materials include, but are not limited to polyolefins, for example, polypropylene and/or polyethylene.

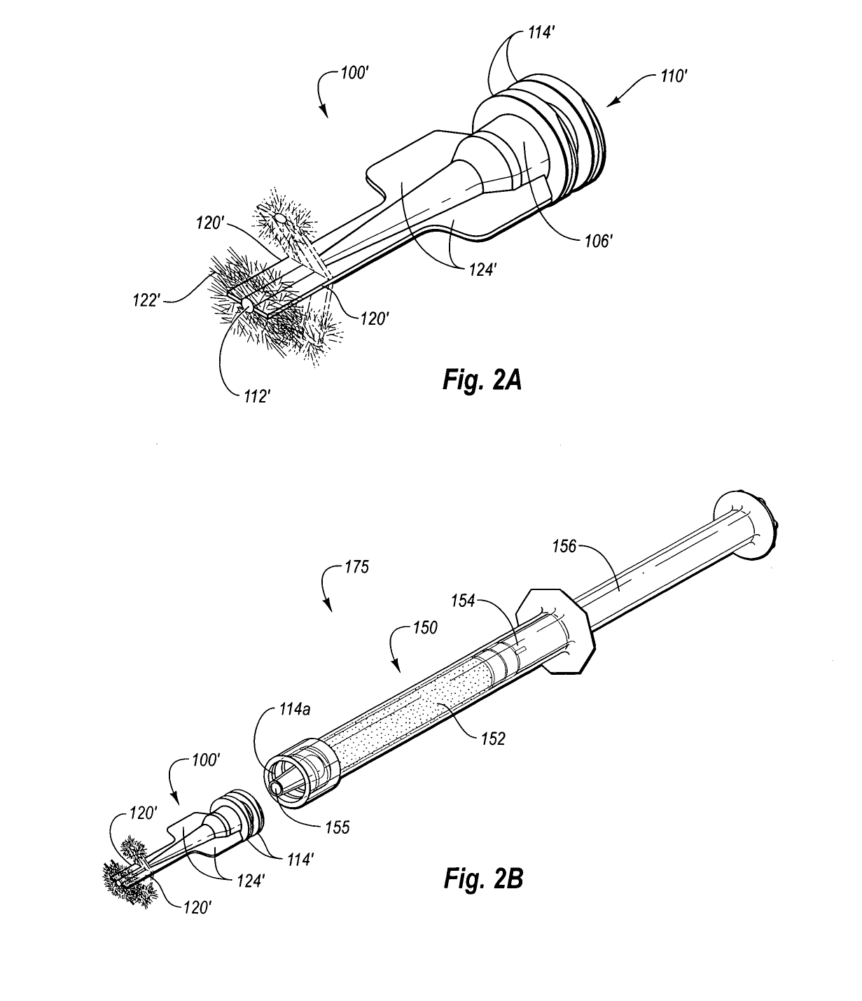

FIG. 2A illustrates an alternative delivery tip 100′. Tip 100′ includes a hollow syringe body 106′, a passageway (not shown) extending between an inlet orifice 110′ and a delivery orifice 112′, enlarged wing element 120′ extending laterally outwardly adjacent delivery orifice 112′, and fibers 122′ attached to the distal portion of wing element 120′. Wing element 120′ extends proximally so as to be integrally formed with torque flanges 124′. Such a configuration may provide an advantage during manufacture by injection molding as it simplifies molding. Furthermore, extending wing element 120′ proximally as illustrated provides a visible guide that the practitioner can use to more easily gauge where the fiber flocked distal portion of delivery tip 100 is relative to the labial face of the molar during application of a fluoride varnish composition. This may be particularly helpful as it can be difficult to see exactly where the flocked distal part of the wing element are relative to the molar when inserted deep into the patient's mouth between the patient's teeth and cheek. A proximally extending wing element of constant width (i.e., the width near torque flanges 124′ is approximately the same as the width adjacent delivery orifice 112′) provides a gauge that is more likely to be visible to the practitioner when the distal portion is inserted into the patient's mouth.

Delivery tip 100′ is also illustrated as including a wing element 120′ and a delivery orifice 112′ that extend distally approximately the same length, as opposed to tip 100, where wing element 120 extends distally beyond delivery orifice 112.

FIG. 2B is a perspective view of a system 175 including delivery tip 100′ and a syringe container 150 to which tip 100′ is coupleable so as to allow a dental practitioner to deliver a composition 152 within syringe 150. Although illustrated using tip 100′, it is to be understood that tip 100 may alternatively be used. Syringe container 150 is an example of a container that may be coupled to the inventive delivery tip for use in dispensing and applying a composition contained within container 150.

In general, container 150 includes a hollow cylindrical barrel 154 (e.g., a syringe barrel) including an inner wall and a barrel outlet orifice 155, and a plunger 156 slidably disposed within hollow barrel 154 for selectively expressing the contained composition 152 (e.g., a fluoride varnish composition having a viscosity of at least about 1000 centipoise) through the barrel outlet orifice of the hollow barrel and into the inlet orifice of the tip body 100′. The illustrated embodiment further includes a cylindrical skirt portion distal to barrel 154 with internal engagement groves 114a configured for coupling with threads 114′ of delivery tip 100′. Syringe container 150 may advantageously comprise a single dose syringe. In other words, syringe 150 may be sized so as to hold a volume of composition 152 sufficient for use with only a single patient, allowing the system to be discarded after a single use.

FIG. 3A illustrates the syringe system 175 which includes the syringe 150 and delivery tip 10′ in use according to the present invention. As can be seen in FIG. 3A, during use the delivery tip 100′ is inserted within the mouth of a child 180 or other patient in order to, for example, apply a high viscosity fluoride varnish composition to the patient's teeth. FIG. 3B shows a cut away view of the delivery tip 100′ being used to apply dental composition 152 to the patient's teeth, beginning with molars 182. As seen in FIG. 3B, the application width (i.e., the width of the wing element plus twice the average length of fibers) is advantageously approximately equal to the height of the child's molars 182. During application, the wing element is pulled along the labial surface of molars 182 (and subsequently the forward teeth also). As described above, the distal portion of tip 100′ may advantageously be bendable and angled so as to better reach and apply composition into the interproximal spaces between the teeth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A delivery tip for controllably dispensing and applying a high viscosity dental composition to a person's teeth, comprising:
a tip body including a passageway extending from an inlet orifice at a proximal end to a delivery orifice at a distal delivery end of the tip body;
an enlarged wing element adjacent the distal delivery end, the enlarged wing element extending substantially laterally outwardly from the distal delivery end; and
a plurality of fibers disposed on at least a portion of the enlarged wing element;
wherein a ratio of a width of the enlarged wing element to an inside diameter of the delivery orifice is at least about 5:1 so as to provide control over the flow of composition through the delivery orifice while also providing an application width that is significantly wider than the delivery orifice.

2. A delivery tip as recited in claim 1, wherein a distal portion of the tip body is bendable so as to allow a user to bend the distal delivery end of the tip body to an angle relative to the inlet orifice at the proximal end.

3. A delivery tip as recited in claim 2, wherein the distal portion of the tip body comprises a notch so as to define a plane about which the distal delivery end of the tip body will preferentially bend.

4. A delivery tip as recited in claim 2, wherein the distal portion is bendable so as to provide an angle between about 20° and about 70° between the inlet orifice and the delivery orifice.

5. A delivery tip as recited in claim 2, wherein the distal portion is bendable so as to so as to provide an angle between about 30° and about 60° between the inlet orifice and the delivery orifice.

6. A delivery tip as recited in claim 2, wherein the distal portion is bendable so as to so as to provide an angle between about 40° and about 50° between the inlet orifice and the delivery orifice.

7. A delivery tip as recited in claim 1, wherein a portion of the passageway adjacent the delivery orifice at the distal delivery end of the tip body comprises an untapered portion of constant inside diameter.

8. A delivery tip as recited in claim 1, wherein the enlarged wing element includes two sub-portions, each sub-portion extending substantially laterally outwardly from opposite sides of the tip body such that the two sub-portions are in substantially the same plane.

9. A delivery tip as recited in claim 1, further comprising at least one torque flange, and wherein the enlarged wing element extends proximally from the distal delivery end to the at least one torque flange.

10. A delivery tip as recited in claim 1, wherein the enlarged wing element extends distally beyond the delivery orifice.

11. A delivery tip as recited in claim 1, wherein the enlarged wing element has a width in a range of about 2.5 mm to about 12 mm.

12. A delivery tip as recited in claim 1, wherein the enlarged wing element has a width in a range of about 3 mm to about 9 mm.

13. A delivery tip as recited in claim 1, wherein the enlarged wing element has a width in a range of about 3.5 mm to about 6 mm.

14. A delivery tip as recited in claim 1, wherein the width of the enlarged wing element plus twice an average fiber length of the plurality of fibers disposed on the enlarged wing element is in a range of about 6 mm to about 8 mm.

15. A delivery tip as recited in claim 1, wherein the delivery orifice has an inside diameter in a range of about 0.003 inch to about 0.04 inch.

16. A delivery tip as recited in claim 1, wherein the delivery orifice has an inside diameter in a range of about 0.005 inch to about 0.03 inch.

17. A delivery tip as recited in claim 1, wherein the delivery orifice has an inside diameter in a range of about 0.01 inch to about 0.025 inch.

18. A delivery tip as recited in claim 1, wherein the ratio of the width of the enlarged wing element to the inside diameter of the delivery orifice is at least about 9:1.

19. A delivery tip as recited in claim 1, wherein the ratio of the width of the enlarged wing element to the inside diameter of the delivery orifice is at least about 15:1.

20. A delivery tip as recited in claim 1, wherein the ratio of the width of the enlarged wing element to the inside diameter of the delivery orifice is at least about 20:1.

21. A delivery tip as recited in claim 1, wherein the plurality of fibers comprise electrostatically applied flocked fibers.

22. A delivery tip for controllably applying a high viscosity dental composition to a person's teeth, comprising:
a tip body including a passageway extending from an inlet orifice at a proximal end to a delivery orifice at a distal delivery end of the tip body;
an enlarged wing element adjacent the distal delivery end, the enlarged wing element extending substantially laterally outwardly from the distal delivery end;
a plurality of fibers disposed on the enlarged wing element; and
means for controlling flow of the high viscosity dental composition through the delivery orifice while also providing an application width that is at least about 5 times wider than the delivery orifice.

23. A delivery tip as recited in claim 22, wherein the means for controlling flow of the high viscosity dental composition through the delivery orifice while also providing an application width that is significantly wider than the delivery orifice comprises forming an enlarged wing element and the delivery orifice such that a ratio of the width of the enlarged wing element to an inside diameter of the delivery orifice is at least about 9:1.

24. A delivery system for applying a high viscosity fluoride varnish composition to a person's teeth, comprising:
a container comprising:
a hollow barrel including an inner wall and a barrel outlet orifice, the hollow barrel being configured to contain a high viscosity fluoride varnish composition; and
a plunger slidably disposed within the hollow barrel for selectively forcing a high viscosity fluoride varnish composition through the barrel outlet orifice of the hollow barrel; and
a delivery tip coupleable to a distal end of the container adjacent the barrel outlet orifice, the delivery tip comprising:
a tip body including a passageway extending from an inlet orifice at a proximal end to a delivery orifice at a distal delivery end of the tip body;
an enlarged wing element adjacent the distal delivery end, the enlarged wing element extending substantially laterally outwardly from the distal delivery end; and
a plurality of fibers disposed on the enlarged wing element;
wherein a ratio of the width of the enlarged wing element to an inside diameter of the delivery orifice is at least about 5:1.
